(19) United States
(12) Patent Application Publication
(10) Pub. No.: US 2012/0289109 A1
(43) Pub. Date: Nov. 15, 2012

(54) Method For Manufacturing A Part Of A Composite Material And Part Thus Obtained

(75) Inventors: Sébastien GOHIER, La Montagne (FR); Philippe BLOT, Nantes (FR); Christophe MARCHAND, Reze (FR); Maxime PROVOST, Nantes (FR)

(73) Assignee: AIRBUS OPERATIONS SAS, Toulouse Cedex (FR)

(21) Appl. No.: 13/467,258

(22) Filed: May 9, 2012

(30) Foreign Application Priority Data
May 10, 2011 (FR) 1154022

(51) Int. Cl. B29C 45/14; B29C 45/26; B32B 27/04; B29C 45/18

(52) U.S. Cl. 442/59; 264/102; 425/117

(57) ABSTRACT

The manufacturing method includes a step of resin transfer moulding, wherein resin is injected (E) in a preform (1), which is placed in a closed mold (2) and said preform (1) is degassed during the whole resin injection operation of this step of resin transfer moulding.

The present invention relates to a method for manufacturing a part in a composite material.

It applies more particularly to the manufacture of a part, for instance a panel in a composite material, which can be used in numerous fields (automobile, etc.) and including in aeronautics. Such a panel or a part can specifically used to make a structural member of an aircraft, for example a transport airplane.

It is known that, in the aeronautical field, an increasing part of the usual metallic parts tends to be replaced by parts in a composite material due to the advantages of the latter, namely:
a mass gain;
good mechanical properties; and
an absence of corrosion.

The present invention more particularly relates to a method for manufacturing a part in a composite material, which comprises a resin transfer molding of the RTM (“Resin Transfer Molding”) type, which is well known (FR 2,798,618, EP-1,342,556, FR 2,740,379) and during which a resin is injected in a reinforcing member made of a textile preform located in a mold.

For implementing such a resin transfer molding step of the RTM type, a dry textile preform is thus put in a mold being closed either by a mechanical system (screw, press, lock, etc.) or by a vacuum action in the peripheral area. The resin is introduced in the mold thru one or more orifices called “injection points”. It also goes out thru one or more orifices being different from the injection points and commonly called “vents”. The resin injection in the mold is provided thru a vacuum pulling thru the vents and/or by a pressure applied in an injection pot, said injection points are connected to.

Upon the resin injection (being performed according to a rectilinear line), after a certain distance covered in the preform, the resin front is no longer be rectilinear, and this, even if the resin is injected on a continuous way. Such distortions are generated due to differences in the preform permeability and preferential paths between the preform and the mold. Such distortions generally increase as a function of the distance covered by the resin in the preform.

In presence of the preferential paths on the edges of the mold, there is the risk that resin front lines close on themselves, and therefore capture residual air in the preform. When the resin goes out of the mold thru the vents, the injection is stopped so as to avoid the use of a big quantity of resin and the vacuum mastery in the mold is no longer possible. Generally, captured air pockets stay, thereby generating within the part porosities being:
either very localized under the shape of porosities crossing the part. It is then a so-called dry area;
or diffused, what generates a diffused porosity in an area of the manufactured part.

Moreover, during the injection operation, the core impregnation of the reinforcing wicks is not always coordinated with the movement of the resin front. Such core impregnation is concretized by a residual air rejection within the wicks by the resin, upon the impregnation of the latter by capillarity. Such residual air, if it is not eliminated upstream or at the level of the resin front, will stay in the part. It will then create porosities within and on the surface of the part (such porosities tending to move toward the surface thanks to the Archimedes' principle).

The present invention has as an object to remedy such disadvantages. It relates to a method for manufacturing a part in a composite material, comprising a resin transfer molding step of the RTM type, which allows a part presenting not the above mentioned defects to be manufactured.

With this end in view, according to the invention, said manufacturing method comprising a resin transfer molding step of the RTM type, during which resin is injected in a preform located in a closed and rigid mold, is remarkable in that said preform is degassed during the whole resin injection operation upon said transfer molding step.

The present invention thus aims at degassing the preform, i.e. eliminating the gasses and including the air present within and on the preform, and thus, during the whole resin injection operation in said preform. Such degassing operation allows the impregnation quality of the manufactured part to be improved and the generation of porosities to be avoided in the part at the level of internal areas (further to a closure of injection fronts, as above mentioned) and upon core impregnations of reinforcing wicks of the preform.

Such absence (or at least such minimization) of porosities increases the quality of the composite material being obtained, and in particular the mechanical resistance thereof.

The present invention thus allows to substantially improve a usual method of resin transfer molding of the RTM type.

Consequently, thanks to the invention, when the flow rate of the resin becomes nil upon the resin injection, it is sure that the part has been completely subjected to an injection with a good degassing of the preform, which reduces very strongly the risk to obtain dry areas or porous areas in the part so that the material being obtained is homogenous and mechanically acceptable.

In order to provide a permanent degassing in the closed mold, upon the transfer molding step, said mold is located under a vacuum bag and the air being present in the preformed and in the mold is sucked thru the aspiration holes practiced in at least one part of said mold.

Moreover, to improve degassing, advantageously:
the aspiration hole density is important so as to obtain a substantially uniform degassing on the surface of the manufactured part; and/or
at least some of said aspiration holes present a conical shape tapering toward the inside of the mold, which enables to avoid to mark the surface of the part and to perform an easy removal from the mold after resin polymerization.

Moreover, to avoid sucking resin, which would slow down significantly the advance of the resin front and reduce the vacuum mastery in the mold, the air aspiration is performed preferably across a semi-tight membrane, i.e. a membrane which is air permeable and resin tight, such semi-tight membrane being arranged advantageously at the output of the aspiration holes.

However, it is also possible to arrange such semi-tight membrane between the preform and the mold if the geometry of the part to be manufactured allows it, a semi-tight membrane being little deformable (the deformation thereof would reduce its permeability to the resin).

The fact of generating a depression for degassing also enables to hold the mold closed with no mechanical system, such as screws or presses. The mold is located under a vacuum bag and the atmospheric pressure provides a sufficient force to hold in place the different parts of said mold.

The present invention also relates to a mold being intended to the implementation of the resin transfer molding step of the above mentioned method.

According to the invention, at least one part of said mold, comprising preferably two cooperating parts, is specifically provided with aspiration through-holes, presenting the characteristics being detailed hereinabove, so as to allow for degassing of the preform.

The FIGS. of the accompanying drawing will make well understood how the invention can be implemented. On such FIGS., identical references designate similar elements.

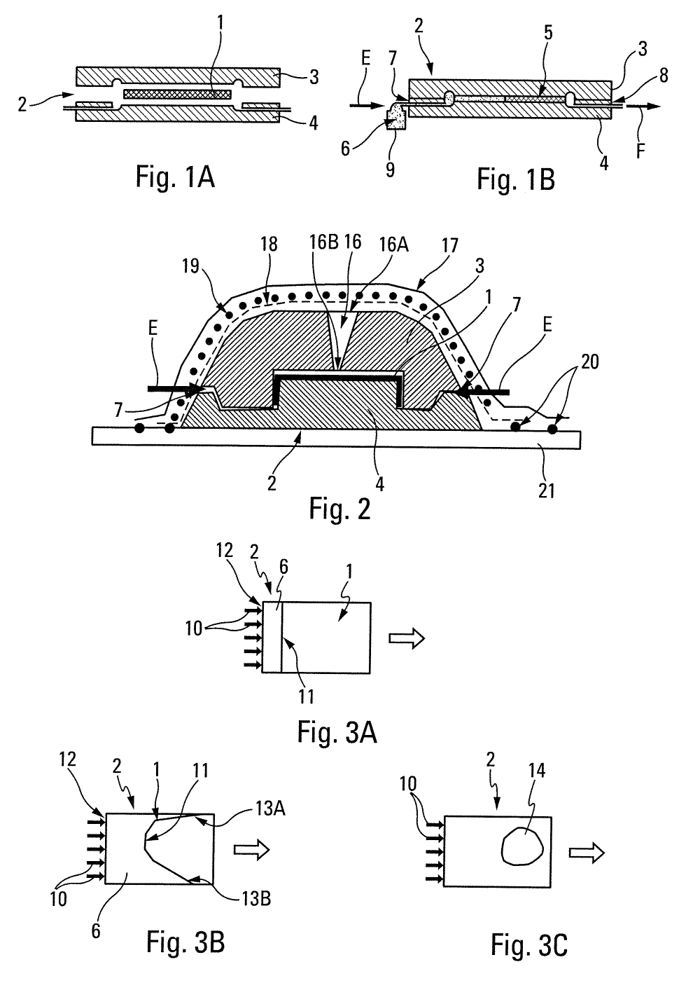

The FIGS. 1A and 1B schematically show two successive times upon the implementation of a resin transfer molding step, the present invention is applied to.

FIG. 2 schematically shows a mold being used upon the implementation of the present invention.

FIGS. 3A, 3B and 3C relate to the state of the art and show the generation of defects at the level of a preform, which a manufacturing method according to the invention allows to remedy.

The present invention relates to a method for manufacturing a part in a composite material to be used in numerous fields (automobile, etc.) and including in aeronautics. Such a part in a composite material generally comprises a fibrous structure being embedded into a matrix made of a resin.

To do so, the present invention aims at improving a usual manufacturing method, generally comprising for example the following usual steps:
one step to make a preform 1 being usual for the part to be manufactured. With this end in view, any known technique can be used, for example, a braiding technique or a draping technique, so as to obtain a preform of dry fibers; and
one step of resin transfer molding of the RTM (“Resin Transfer Molding”) type, wherein:
a dry textile preform 1 is put in an injection mold 2 (FIG. 2) which is then closed. The mold 2 being preferably made of two rigid portions 3 and 4, as schematically represented on FIG. 1A, limits, when it is closed, an internal cavity 5, the shape and the size of which correspond to those of the part to be manufactured;
resin 6 is injected in a reinforcing member made of the textile preform 1 located in the mold 2 being closed. The resin 6 is introduced in the mold 2 thru one of more orifices 7 being so-called injection points, as schematically illustrated by arrows E on FIGS. 1B and 2. The resin 6 goes out from the mold 2 thru one or more orifices 8 which are different from the injection points 7 and are called vents, as schematically illustrated by an arrow F on FIG. 1B. The injection of resin 6 in the mold 2 is provided by an vacuum pulling thru the vents and/or by a pressure applied in an injection pot 9, to which said injection points 7 are connected. In the example of FIG. 1B showing an injection upon an implementation, the left half of the preform 1 is impregnated with resin 6;
the mold 2 is usually heated so as to polymerize the resin 6 (when the resin is not polymerized at room temperature); and
a removal from the mold is performed so as to obtain the part manufactured in a composite material.

The present invention aims at improving such method so as to obtain a part in a composite material containing no porosities and presenting including improved mechanical properties.

With that in view, according to the invention, said preform 1 is degassed during the whole injection operation of the resin 6 upon said transfer molding step, so as to eliminate the gasses and including the air present in the preform 1 (and in the mold 2). Such degassing operation allows the impregnation quality of the part to be manufactured to be improved, and the generation of porosities in the part to be avoided at the level of internal areas (further to a closure of injection fronts) and upon core impregnation of reinforcing wicks of the preform 1. Such absence of porosity improves the quality of the obtained part in a composition material, and in particular the mechanical resistance thereof.

As an illustration, with the usual method without the implementation of the present invention, upon the injection of the resin 6 (arrows 10 on FIGS. 3A, 3B and 3C), after a certain distance covered in the preform, the resin front 11 is no longer rectilinear, as represented on FIG. 3B, and this, even if the resin 6 is injected on a continuous way for example on a rectilinear edge 12 of the fibrous preform 1 (FIG. 3A). Those distortions (illustrated by projections 13A and 13B on FIG. 3B) are generated due to permeability differences of the preform 1 and preferential paths between the preform 1 and the mold 2. Such distortions 13A and 13B generally increase as a function of the distance covered by the resin 6 in the preform 1. In presence of preferential paths on the edges or on the surface of the mold, there is a risk that resin front lines close on themselves, and consequently capture residual air in the preform 1, as represented on FIG. 3C. When the resin goes out from the mould 2 thru the vents 8, the injection is stopped so as to avoid using a lot of resin (and the vacuum pressure mastery in the mold is no longer possible). Generally, the air pockets 14 being captured stay, which will generate porosities in the part. The degassing according to the invention allows such air pockets 14 to be eliminated and thereby prevents the appearance of porosities in the part.

According to the invention, to perform such degassing, with usual aspiration means, the residual air being present in the preform 1 and in the mold 2 is sucked thru the aspiration holes 16 practiced in at least one part of the mold 2, for instance in the upper portion 3 of the mold represented on FIG. 2.

The present invention thus allows a usual method of resin transfer molding of the RTM type to be substantially improved.

Consequently, thanks to the invention, when the flow rate of the resin 6 becomes nil upon the injection of resin 6, it is sure that the preform 1 has been completely subjected to an injection with a good degassing, which thus reduces very strongly the risk to obtain dry areas or porous areas in the part so that the part (in a composite material) being obtained is homogenous and mechanically acceptable.

To provide a permanent degassing in the closed mold 2, upon the transfer molding step, said mold is put under a vacuum bag 17 of the usual type and the residual air in the preformed 1 is sucked thru the aspiration holes 16 practiced in the mold 2. Said aspiration holes 16 are provided preferably in the vicinity of vents 8 of the mold 2.

Moreover, the density of the aspiration holes 16 is important enough to obtain a quasi uniform degassing on the surface of the preform 1 (for example being staggered with a pitch of about 70 to 100 mm).

The size of the aspiration holes 16 on the side 16B of the preform 1 is small (with a diameter of 1 to 2 mm for instance) in order to avoid marking the surface of the preform 1 and enable an easy removal from the mold after polymerization of the resin 6.

Moreover, in order to be able to remove the resin 6 from the portion 3 of the mold 2, the aspiration holes 16 preferably present a conical shape tapering toward the inside of the mold 2, from the external opening 16A to the internal opening 16B. The shrinkage of the resin due to the polymerization of the resin 6 and the thermal shrinkage of the resin 6 with respect to the material of the mold, when the polymerization occurs at a temperature, favors the removal from the mold.

Furthermore, to avoid sucking too much resin 6, which would slow down on a significant way the advance of the resin front 11 (and to hold a good vacuum mastery within the mold), the aspiration of the air is preferably performed thru a semi-tight membrane 18, i.e. a membrane which is airtight and tight to the resin 6, and which is preferably arranged at the output of the aspiration holes 16, outside the mold 2, as represented on FIG. 2.

However, it is also possible to arrange this semi-tight membrane between the preform 1, and the mold 2 if the geometry of the part to be manufactured allows it, a semi-tight membrane being little deformable.

The fact to apply a depression for degassing also allows the mold 2 to be held closed with no use of a mechanical system of the screw of press type. The mold 2 is put under a vacuum bag 17, and the atmospheric pressure provides a sufficient force to hold in place the different portions 3 and 4 of the mold 2.

On the example of FIG. 2, there are also represented:
a vacuum drainage felt 19;
sealing gaskets 20; and
a support 21, on which the mold 2 rests.

Furthermore, due to the degassing quality during the whole injection operation, when the distances covered by the resin 6 are not too important (for example, 300 to 500 mm for a preform 1 made by stacking multi-axial materials with a fiber volume rate of about 60%), the injection of the resin 6 cannot be provided only by a vacuum pulling, i.e. with no application of an injection pressure higher than the atmospheric pressure in the injection pot 9. However, the mold 2 and the set of above mentioned associated means cannot be located in an enclosure under pressure to be able to obtain an injection pressure higher than the atmospheric pressure.

For parts of big sizes (the smallest of the sizes higher than 300-500 mm), a method of the LRI type, i.e. with surface diffusion of the resin under the preform can be contemplated with the invention.

Furthermore, the pressure of the resin 6 in the closed mold 2 is lower than the injection pressure, even theoretically equal at the end of the injection operation when the load losses in the preform 1 and in the injection tubes become nil thanks to the cancellation of the resin flow rate. Consequently, such pressure in the mold 2 is perfectly controllable and very close to the atmospheric pressure (if a pressure in the injection pot 9 is held close to the atmospheric pressure), which does not generate any substantial distortion of the mold 2, and therefore, allows a mold part to be obtained with a very good geometrical precision.

The implementation of the present invention thus allows also the following advantages to be obtained:
a good health for the composite materiel being obtained;
a simplified closure of the mold 2;
an injection under a vacuum bag, thereby allowing the use of a very cheap mold 2; and
a good mastery of the thicknesses.

1. A method for manufacturing a part in a composite material, said method comprising a resin transfer molding step, during which resin (6) is injected into a preform (1) located in a closed and rigid mold (2), so as to manufacture said part in a composite material, and said preform (1) is degassed during the whole injection operation of the resin (6), characterized in that, during the transfer molding step, to perform the degassing, the mold (2) is put under a vacuum bag (17).

2. The method according to claim 1,
characterized in that the air present in the preform (1) and in the mold (2) is sucked thru aspiration holes (16) practiced in at least one portion (3) of the mold (2).

3. The method according to claim 2,
characterized in that the density of the aspiration holes (16) is selected so as to obtain a substantially uniform degassing.

4. The method according to claim 2,
characterized in that at least some of said aspiration holes (16) present a conical shape tapering toward the inside of the mold (2).

5. The method according to claim 2,
characterized in that the aspiration of the air is performed thru a semi-tight membrane (18), which is airtight and tight to the resin (6).

6. The method according to claim 5,
characterized in that said semi-tight membrane (18) is arranged at the exit of the aspiration holes (16).

7. The method according to claim 5,
characterized in that said semi-tight membrane (18) is arranged between the preform and the mold.

8. The method according to claim 1,
characterized in that, upon the transfer molding step, the mold (2) is held closed only with the help of the atmospheric pressure with respect to a depression created by aspiration upon degassing.

9. A part in a composite material,
characterized in that it is obtained by implementation of the method according to claim 1.

10. A mold for implementing the resin transfer molding step according to claim 1,
characterized in that at least one portion (3) of said mold (2) is provided with aspiration through-holes (16).
